(19) United States
(12) Patent Application Publication
(10) Pub. No.: US 2016/0082478 A1
(43) Pub. Date: Mar. 24, 2016

(54) SIZE-SEPARATION OF DRY GRANULAR MATERIALS

(71) Applicants: Otis Walton, Livermore, CA (US); Christopher Dreyer, Lakewood, CO (US); Edward Riedel, Boulder, CO (US)

(72) Inventors: Otis Walton, Livermore, CA (US); Christopher Dreyer, Lakewood, CO (US); Edward Riedel, Boulder, CO (US)

(21) Appl. No.: 14/788,613

(22) Filed: Jun. 30, 2015

(51) Int. Cl. B07B 1/22

(52) U.S. Cl. CPC B07B 1/22

(57) ABSTRACT

A dry granular material sieve operates well in microgravity because it comprises a rotatable cylindrical or conical screen to generate centrifugal forces sufficient to sift finer particles inside through to the outside, and auger screw conveyors to move the fines, coarse, and remainder materials without the aid of normal gravity.

### 1. FIELD OF THE INVENTION

The present invention relates generally to mechanical size separation of dry granular solid materials, and more particularly to sieving in micro-gravity environments with cylindrical or conical rotating screens rotated fast enough to generate sufficient centrifugal force on an inner input feed of material that the finer particles will pass through to an outer collection housing.

### 2. DESCRIPTION OF THE PRIOR ART

In normal gravity, dry granular solids will naturally size-segregate whenever they are poured in a shear flow from one container to another. The large particles tend to rise to the top, and the fines tend to sift to the bottom.

Two things contribute to such size segregation, a dynamic-sieve phenomenon, and a larger particle rolling over smaller particle phenomenon. The fine particles are more-mobile and can move into openings below them faster that larger particles can. The fine particles naturally migrate then toward the bottom, especially with a vibrated bed. Under certain conditions of vertical vibration, the larger particles will rise to the top, the so-called “Brazil nut” problem.

The larger particles will gain spin when vibrated and roll up-and-over smaller particles in a shearing flow. The effective grain-to-grain friction coefficient μ is a critical parameter in such sorting processes. If μ is too small, a larger spherical grain cannot get sufficient purchase to roll over neighboring particles without slipping. Irregularly shaped particles invariably will rotate whenever a granular bed shears. The average rotation rate of particles in a shearing flow is proportional to the local shear-rate in the bed.

The dynamic-sieving mechanism manifests both in shearing flows and non-shearing situations. Vibratory-screen sifters take advantage of the natural tendencies of finer grain solids to sift down to the bottom in both vibratory and shearing flows. When a container in normal gravity is vibrated or oscillated, the fines fraction will migrate to the bottom. If a fine screen is placed on the bottom, both gravity and the contact forces from the granular bed above will push the fines through the screen. The coarse fraction is left on top of the screen.

In reduced gravity conditions, vibratory-screen sifters do not function well for separation of small (e.g., sub 0.15 mm range) particles. Such conditions are expected during in situ resource recovery operations on the Moon, as was demonstrated in reduced-gravity flights.

Trommel screens are slowly rotated, nearly horizontal, cylindrical screens, partially filled with granular material and used in normal gravity. These have been used for centuries to screen and size-separate granular solids like sands and gravels. Such function very well terrestrially for segregating out particulates larger than one centimeter. Trommel Screens are used extensively in mining and mineral industries to remove oversize rocks from feed stocks before processing.

Most Trommel screens are designed for dry granular materials. However, some are liquid-solid-slurry versions adapted to separate denser ores from lighter materials.

Trommel screens are less effective when smaller particle size dry materials or cohesive materials are involved. So other configurations are preferred. The rotation rate of a Trommel screen cannot be increased beyond a critical speed in which centrifuging of the solids onto the outer wall occurs. Such high levels of centrifuging stops any shearing flows.

Smaller size particle separation units working down to about 0.1 mm include one variety known as “centrifugal-sifters” or “centrifugal-screens”. They use relatively fast rotating paddle blades or wheels inside a stationary cylindrical screen to separate dry fines from coarse solids. Companies such as Russell Finex Ltd., UK; Kason Corporation, Millburn, N.J.; S. Howes, Inc., NY; or Jiangyin Wanlu Machine Mfg., Jaingsu, China, all sell “centrifugal”-sifters or screens which work on nearly the same principle.

These paddle wheel sifters often use a spiral auger to move material to the paddle-blade section where it is sheared over a screen. The rotation rates of the paddle blades are high enough that centrifugal force can be depended upon to fling the fines out to an outer cylindrical screen. The oversize materials are retained inside the mesh screen. These are pushed towards an outlet end opposite the inlet feed by a slight spiral angle of the paddle blades that ejects them from the machine.

Paddle-wheel centrifugal sifters are effective, in part, due to the effects of entrained air circulated by the paddle blades. But, problems with machine wearing can be serious if highly abrasive materials are being processed. Under vacuum conditions, as can be encountered in space-mission applications, their effectiveness is doubtful.

Most rotating-screen solids centrifugal systems are two-phase fluid-solid systems. The most common centrifugal separators for solids do not use rotating mechanical parts, instead their mechanical hardware is stationary. Flows of two-phase mixtures are used in gas-solid cyclone separators or hydro-cyclones. These primarily separate solids from gases or liquids, and can also select particulates with specific sizes.

De-watering, and other separations of liquids from solids, often use rapidly rotating cylindrical or conical outer screens with porous walls to pass liquids through while the solids are detained inside. A familiar example is the use of a spin cycle in a typical clothes washing machine. The wash water is flung out through straining holes in a cylindrical wash tub that is briefly rotated at high speed. The clothes are thus left dewatered inside at the end of the spin cycle. The little bit of remaining moisture is easy evaporated with a hot-air dryer.

Rotating mechanical screen-scroll centrifuges are routinely used to dewater coal ores, paper slurries, and other wet particulates. Such centrifuges use very high rotational speeds. Typical ones have 10°-30° half-angle conical screens, or cylindrical outer screens. The screen openings range in size from 0.25 mm to one millimeter.

The primary applications are liquid-solid separation, allowing liquid to pass through the outer screen wall while retaining the desired particulate product inside the screen. These dewatering systems are often configured in continuous-flow mode with mixed liquid-solid material entering the system and separate solid and liquid streams leaving the equipment. Solids are often conveyed by a continuous helical screw.

Large water and wastewater treatment industrial centrifuges commonly employ batch-mode operations to dewater sludge into a dry cake-bed that must be periodically removed.

Dewatering centrifuges can use cylindrical and/or conical screens in horizontal or vertical orientations. In continuous mode operations, cylindrical screen centrifuges with rotating helical (screw) blades move dried solid cake material to the exits. Some use a traveling scraper blade.

Conical screen centrifuges can use a straight “peeler” blade, a tapered helical scroll blade. Or they can use vibrations to move and convey cake material from the small end to the large while drying it. Screen life can be improved significantly by pre-accelerating the slurry up to the centrifuge wall speeds.

Vibrating conveyer conical dewatering centrifuges use a high frequency axial or radial excitations to partially “fluidize” the materials on the screen wall. This lowers the effective wall friction and allows it to move along toward the larger end and out. The half-angles of conical screen used in dewatering centrifuges is usually between 18° and 25°. Screen suppliers typically stock conical screens for centrifuges with half-angles ranging from 10° to 30°.

Most continuous centrifuging processes involving solids seem to depend on conical screens. The solids are moved from the small end inlet to the large end outlet of the screen by vibration or mechanical pushing. There appears to be no commercial dry solids separators based on rotating screen centrifuges. Although screen bowl centrifuges used to dry coal slurries have been studied as potential size-separator devices in a water slurry.

### SUMMARY OF THE INVENTION

Briefly, a dry granular material sieve embodiment of the present invention can operate well in microgravity because it comprises a rotatable cylindrical or conical screen to generate centrifugal forces sufficient to sift finer particles inside through to the outside, and an auger screw conveyor inside to move the coarser materials detained inside axially along to an outlet.

These and other objects and advantages of the present invention no doubt become obvious to those of ordinary skill in the art after having read the following detailed description of the preferred embodiments which are illustrated in the various drawing figures.

### IN THE DRAWINGS

FIG. 1 is a cross-sectional diagram of a centrifuging screen separator of the present invention with a rotating conical circular cylindrical screen;

FIG. 2 is a cross-sectional diagram of a centrifuging screen separator of the present invention with a tilted rotating right circular cylindrical screen which is vibrated to effect axial motion of the material along the screen;

FIG. 3 is a cross-sectional diagram of a centrifuging screen separator of the present invention with a right circular cylindrical screen, similar to the configuration of FIG. 2, except that the axial movement of the material along the inner rotating cylindrical screen is the result of a separately rotated helical screw (or helical brush);

FIGS. 4A, 4B are face and side view cutaway diagrams of a right circular cylindrical centrifuging screen separator of the present invention wherein all gravity-flow components have been replaced with screw-conveyors;

FIG. 5A is a radial cross-sectional diagram of multi-coaxial right circular cylindrical centrifuging sieves of the present invention with a staging of increasingly fine screens;

FIG. 5B is a diagram of a batch sieving embodiment of the multi-stage sieving configuration with multiple annular receptacles for sieved product at the bottom; and

FIG. 5C is a diagram of a continuous size separation embodiment with open annular exits for each size fraction stream.

### DETAILED DESCRIPTION OF THE PREFERRED EMBODIMENT

Sieving mixed, dry granular materials into separate fines and coarse particles generally requires a shearing flow over a screen. Normally gravity can help with this and even push the fines through the screens. But in microgravity environments alternative ways are needed to establish shearing flows of materials and forces to push the fines through the screens.

Embodiments of the present invention are particularly well suited for sieving dry granular materials in micro gravity environments. They spin their screens and use the resulting centrifugal force to move the finer materials through the screens from the insides. Vibrators, screw augers, scrapers, and other kinds of material pushers agitate and migrate the incoming mix and expel the coarser materials from the outlets.

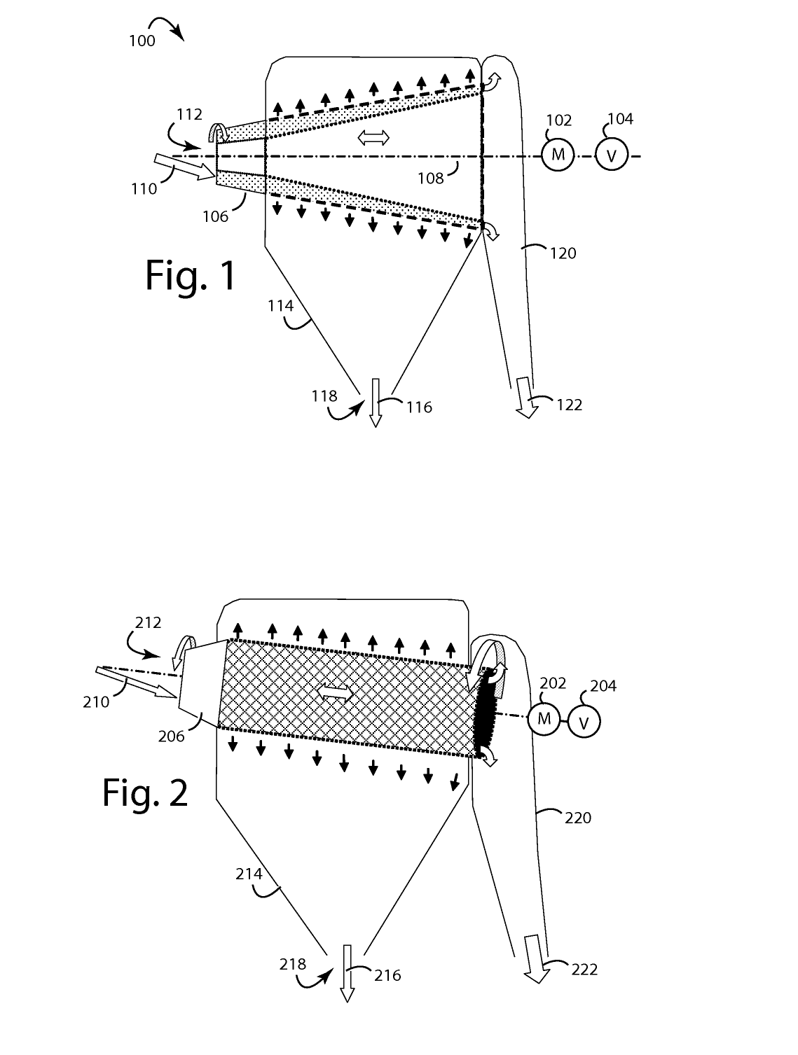

FIG. 1 represents a first embodiment of the present invention, a conical sieve system 100. A speed-controlled motor (M) 102 and a vibrator (V) 104 are attached to spin and vibrate a conical screen 106 that rotates on an axis 108. A dry mix 110 of granular material is continually introduced inside a small end 112 of the conical screen 106. As the mixed-size granular feed stock material enters conical screen 106 it quickly accelerates in a short accelerator section. Axially aligned radial blades can be included here to assist in getting the material accelerated up to the rotation rate.

The granular material forms a relatively uniform layer on the inside of the rotating conical screen 106. A fines collection housing 114 catches and collects the fines 116 that pass through conical screen 106. Under gravity, these will drop out below from a spigot 118. A coarse materials chute 120 conducts away the coarse materials 122 that were too large to pass through conical screen 106. All of gravity, vibration, and centrifugal force on the dry mix 110 help provide the shearing flows needed for separation to work.

In order to achieve the desired separation of size fractions from feedstock, it is necessary to have a relatively thin flowing layer with significant shear and/or vibration so that the coarse fraction will rise all the way to the top, or conversely, so that the fine fraction will migrate all the way to the bottom where the screen is located. A simple conical configuration of the present invention achieves shearing flow throughout the process, starting with the acceleration cone near the entrance. Even at the small end of the acceleration cone, the centrifugal force from the rotation of the unit will exceed gravity by a factor of 1.5 or more. Since material entering the cone will not be traveling at the wall speed, significant sliding and shearing will occur as the material accelerates up to the local wall speed.

In alternative embodiments, the cone half-angle is less than the angle-of-repose of the granular material. The material will therefore stay put against the rotating conical wall at rotation rates in which the centrifugal acceleration at the walls exceed the acceleration of local gravity. Axial or circumferential vibrations can be used to reduce the effective internal friction in the granular material so it can flow along the inner wall of the conical screen. A tapered helical screw, brush, or a blade could also be used to move the material instead of vibrations.

If the cone half-angle is fixed greater than the angle-of-repose of the granular material, such material will flow along the inside of the cone even without vibration assistance. Varieties of materials may be much harder to control in large-angle cone configurations. The axial velocity of the shearing material flowing along the inner conical screen wall will not be as readily controlled by changing the operating parameters of the sieve compared to a narrower-angle cone.

Material flows and shears in these conical screen embodiments due to the increasing screen circumference. The friction increases and causes the material to move slower. The shearing and/or vibrations will migrate the fines to and through the screen. Centrifugal force, vibration, and contact forces from the overburden materials push the fines through in combination. The coarser material that does not pass through the conical screen wall will have no choice but to exit. Conventional mechanisms can be used for mounting, driving, and vibrating the rotating screens, and will not be further described.

FIG. 2 represents a second embodiment of the present invention, an inclined cylindrical sieve system 200. A speed-controlled motor (M) 202 and a vibrator (V) 204 are attached to spin and vibrate a cylindrical screen 206 that rotates on an inclined axis 208. Being “inclined” implies at least some gravity is present. The rotation rate is set such that the material mix experiences a centrifugal acceleration that is at least 1.5 times the acceleration of gravity so that it is centrifuged onto the rotating cylindrical screen and forms a bed of material that is nearly uniform in thickness around the circumference of the cylindrical screen. A dry mix 210 of granular material is continually introduced inside a small end 212 of the cylindrical screen 206. A fines collection housing 214 catches and collects the fines 216 that pass through cylindrical screen 206. Under gravity, these will drop out below from a spigot 218. A coarse materials chute 220 conducts away the coarse materials 222 that were too large to pass through cylindrical screen 206. Again, gravity, vibration, and centrifugal force all combine on the dry mix 210 to help provide the shearing flows needed for separation to work.

The rotation rates and tilt angles are such that material only moves along the walls if vibrations reduce the effective wall friction enough for motion to occur. Those same vibrations induce the size segregation and fines separation through the outer screen. One potential drawback of this configuration is that the same combination of tilt angle and rotation rate will probably not be optimum for both terrestrial and lunar gravity-levels. This configuration would not function under micro-gravity, since there would be no axial driving force to move material through the sieve-screen.

FIG. 3 represents a third embodiment of the present invention, a screw-augured cylindrical sieve system 300. A speed-controlled motor (M) 302 and an optional vibrator (V) 304 are attached to spin and vibrate a cylindrical screen 306 that rotates on a horizontal axis 308. Being “horizontal” implies at least some gravity is present. A dry mix 310 of granular material is continually introduced inside a small end 312 of the cylindrical screen 306. A separately rotated brush or screw auger 313 on a coaxial shaft moves the dry mix 310 along the inside faces of cylindrical screen 306. A fines collection housing 314 catches and collects the fines 316 that pass through cylindrical screen 306. Under gravity, these will drop out below from a spigot 318. A coarse materials chute 320 conducts away the coarse materials 322 that were too large to pass through cylindrical screen 306. The screw auger, gravity, vibration, and centrifugal force all combine on the dry mix 310 to help provide the shearing flows needed for separation to work.

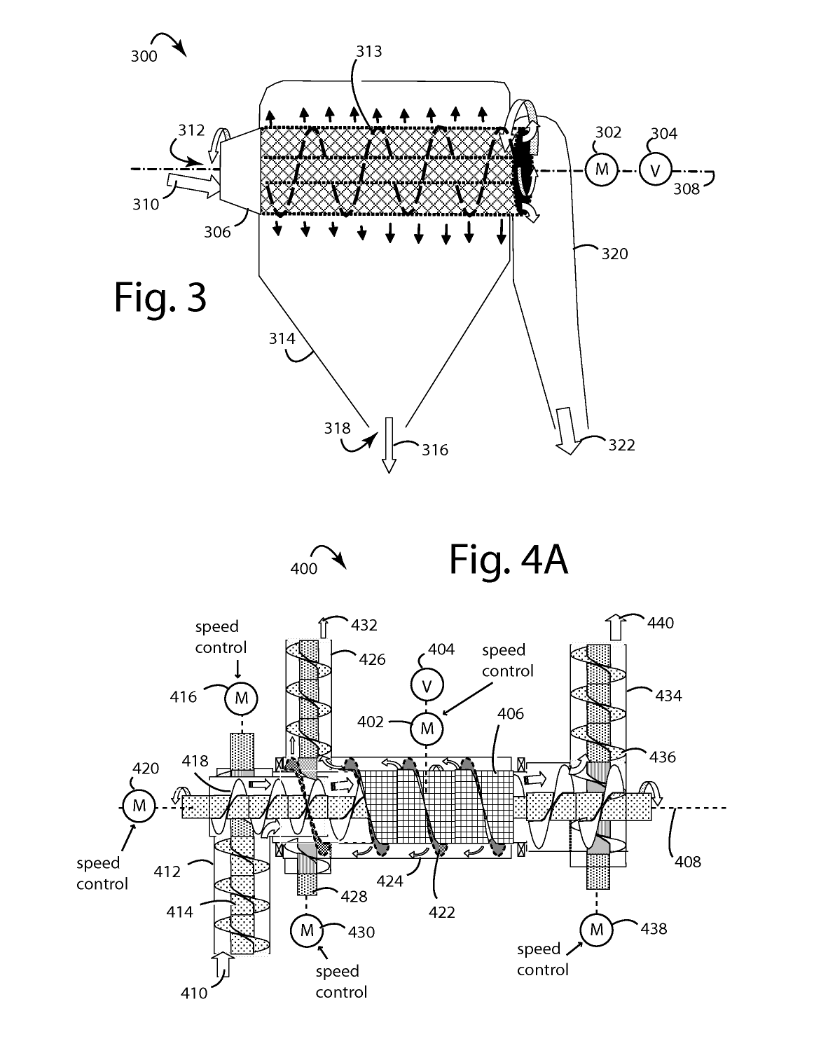

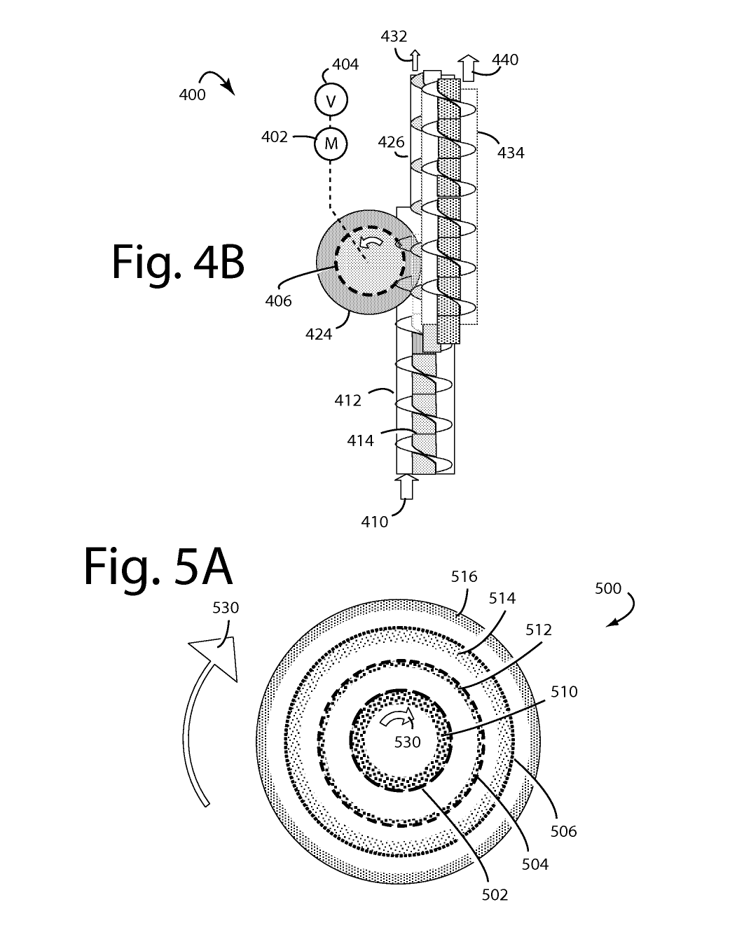

Helical brush or screw auger 313 is typically rotated somewhat faster than the cylindrical screen 306, as that described by Walton et al, 2011 (Apparatus and Method for Conveying Cohesive Materials, U.S. patent application Ser. No. 13/044,328 Publication number: US 2011/0220462 A1). It is similar to a conventional screw conveyor in that it moves material longitudinally along the inside walls of cylindrical screen 306. If the screw rotations were somewhat slower than the screen 308, the “hand” of the screw helix should be opposite to that of a faster rotating screw. That would make continuous feeding with the same screw as described in FIGS. 4A-4B, difficult to accomplish.

If at least some gravitational force is present, an inclined (relative to local gravity) and rotating cylindrical screen can be used. Solids centrifuge to an outer wall surrounding the screen, will inherently have a net axial flow of solids, and shearing. These must be vibrated at appropriate amplitudes and frequencies to overcome the friction that holds the material on the wall enough to allow flow.

FIGS. 4A and 4B illustrate what to do when there is no gravity to rely on. Screw augers are needed to move the fines and coarse materials out and the mix in. The fines and coarse materials will not drop out chutes if there is no gravity.

FIGS. 4A and 4B represent a fourth embodiment of the present invention, a fully screw-augured cylindrical sieve system 400. A speed-controlled motor (M) 402 and an optional vibrator (V) 404 are attached to spin and vibrate a cylindrical screen 406 that rotates on an axis 408. The mesh size of screen 406 is selected to allow particular sizes of fines to pass through.

A dry mix 410 of granular material is continually introduced inside an input mix conveyor 412 with a screw auger 414 turned by a speed-controlled motor 416. The dry mix 410 transfers to an inner screen auger 418 turned inside cylindrical screen 406 by a speed-controlled motor 420. An outside scraper helix 422 is attached to cylindrical screen 406 and turns with it inside a fines collection housing 424.

Fines are conducted by scraper helix 422 to a fines exit conveyor 426. An auger 428 driven by a speed-controlled motor 430 produces a fines output 432. Inside auger 418 delivers the mix 410 that has been relieved of fines 432 to a coarse-materials exit conveyor 434. An auger 436 driven by a speed-controlled motor 438 produces a coarse materials output 440.

The fully screw-augured cylindrical sieve system 400 will function in any orientation with respect to gravity, and will therefore function in true micro-gravity environments. Mixed-size feed stock conveyed to the centrifugal sieve through a screw conveyor is transferred to another rapidly rotating screw conveyor which carries the material into and through the rotating cylindrical screen. Helical screw 418 extends right on through. Cylindrical screen 406 rotates separately. The diameters of individual screw sections may be different. The outer walls surrounding the screw sections are stationary. The rotating screen 406 is supported by separate bearings and turned by separate drive mechanism 402. It can rotate at different speeds than the auger 418.

Conveyors 426 and 434 may carry the separated materials on to collection vessels, or to a next processing step. Conveyors 426 and 434 could, in some cases, be replaced with simple collection shrouds.

Conventional motor controllers can be employed to independently control, vary, and balance the speeds of rotation of circular cylindrical screen, the continuous input dry granular mix material conveyor 412, the continuous output finer particles of material conveyor 426, and the continuous output remaining dry granular mix material conveyor 434.

Centrifugal force, optional vibration, and shearing flows combine to motivate fines through the screens. The driving forces for segregation, flow and screen-passing are nearly independent of gravity. The effectiveness of the sieving can be controlled by the screen rotating and vibration operating parameters.

In horizontal configurations, or in microgravity conditions in all orientations, internal mechanical blades (or screws) can induce shearing and axial displacement of the solids. These new, near-gravity-independent sieves could separate coarse regolith particles from fines under low-gravity and vacuum conditions, with minimal maintenance. The present invention uses a kind of artificial gravity, in the form of the centrifugal force developed inside rapidly rotating screen to provide the primary driving force needed to move particles up to and through the screen. Such can operate in a low gravity environment, and be applied to cohesive materials.

The subject matter of the invention includes sieves and sieving methods that use centrifugal force as the primary body force contributing to size segregation with rapidly-rotated cylindrical (and/or conical) screens. Vibration and shearing flows are induced to facilitate size segregation and eventual separation of the fines from the coarse material. Separate screw auger blade can transport material along the rotating cylinder walls and induce shearing in the material. Such configurations can be used with or without vibration of the outer screen, because the screw auger motion alone can induce the separation and flow of the material.

A similar, but tapered, screw auger blade or brush can be placed inside a centrifuging conical screen instead of applying vibration. This can achieve the axial flow of solids needed with the conical screen. The screw auger approach can function nearly independent of gravity as long as the centrifugal force from the rotating screen exceeds the acceleration of gravity by a significant factor. But since this configuration has a blade or brush rubbing on a screen, it can suffer relatively high rates wear on the screen. A shorter useful-life expectancy than configurations that could shear or sieve the material without the use of such a blade or brush rubbing over the screen.

These centrifuging-screen designs can provide sufficient force on fine particles near the screen to overcome inter-particle cohesion and propel them through the screen openings. The separation process will not depend a dominant gravity field, nor will it depend on airflows. The basic concepts here can be scaled for practically any desired throughput. Such sieves can be applied to screening samples collected on a small robotic mission to an asteroid, or for semi-permanent lunar In Situ Resource Utilization (ISRU) processing operations.

The walls of acceleration cones are not made of conventional screens because they are too vulnerable to damage from wear. Instead, the acceleration cones have solid walls with a few small nearly axial internal ridges or blades that will increase both the effective wall friction and the shearing action on the granular material as it accelerates up to the wall speed. By the time the material is up to the wall speed and enters the screen covered region, it will have already experienced significant shearing flow under a relatively high artificial gravity. The bottom of the flowing layer will already have a high concentration of fines. This will provide appropriate material to pass through the screen and also serve to protect the screen from scrapes with the largest particles which may still be rising to the top surface of the flowing layer.

As the materials proceed along the inside of a conical screen it will shear deform because the circumference of the cone, seen by the material, will be increasing in step with its axial progression toward the large end. The cone angle is less than the angle of repose of the granular solid so that the axial velocity of the material can be controlled by the friction-reducing vibrations. These also serve to increase the rate of size segregation that occurs above the screen. The vibrations reduce the cohesion and friction resistance of the fines passing through the screen, thus increasing the efficiency of the separation.

The change in radius from a conical screen's small end to its large end is typically at least 1:3, e.g., varying from about 2.5 cm to about 7.5 cm. That means the material flowing will experience a large shear strain, apart from any vibrations or changes in material composition.

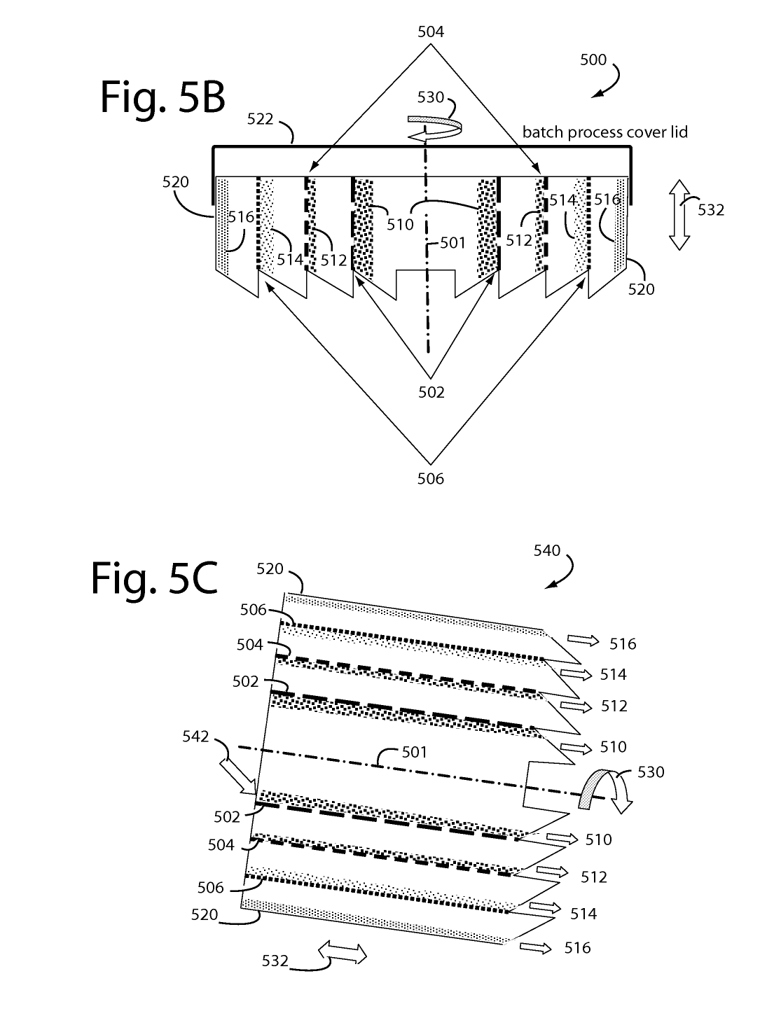

FIGS. 5A-5C represent a cylindrical centrifuging sieve 500 in an embodiment of the present invention that rotates on a single axis 501. Cylindrical centrifuging sieve 500 includes multiple, nested, coaxial screens, e.g., 502, 504, and 506. Each next outward screen with a larger radius is also finer in its mesh, e.g., 502>504>506. Here, four different material-size fractions 510, 512, 514, and 516 can be collected by these three screens. An outer containment shell 520 collects the finest particles 516.

FIG. 5B represents a vertical-axis orientation of cylindrical centrifuging sieve 500 in a local gravity field. This orientation would be useful in batch processing of mix materials. A removable lid 522 is opened, and a batch of feedstock is placed inside of the innermost screen 502. Once the lid is closed, the whole unit can optionally be re-oriented with axis 501 being horizontal, as in FIG. 5A, or it can function in a vertical orientation with centrifugal acceleration and vibration both contributing to distribute the material around the circumference, and inducing the size separation. It is rotated and vibrated as represented by arrows 530 and 532 respectively. The agitations continue until the various size fractions 510, 512, 514, and 516 are separated into respective concentric annular collection regions between the screens.

After spinning is done, the unit could again be oriented with axis 501 vertical, and the separated materials removed from each collection band. The removal is facilitated with sliding “trap-doors” on the bottoms of each. Or the separated materials is removed by opening lid 522, and mechanically scooping material out.

FIG. 5C represents a variation, a tilted cylindrical configuration 540 for continuous processing, similar to that of FIG. 2 but incorporating the coaxial screens of FIGS. 5A-5B. Mixed feedstock material 542 is introduced at the center of the upper end, e.g., inside of the innermost cylindrical screen 502. A coarse stream 510 and multiple fines-streams 512, 514, and 516, flow out doors and chutes on the lower end.

Thus, the batch processing embodiment of the centrifugal sieve as shown in FIGS. 5A-5B comprising a set of concentric cylindrical screens of varying mesh size, ranging from coarse to fine as the radius increases. For use under any environment with or without a finite gravity (e.g. under terrestrial gravity or in true micro-gravity conditions) a mixed-size feedstock material can be placed inside of the innermost cylindrical screen wall with a flat lid fitted over the entire concentric screen set (with seals at each screen) the unit can be rapidly rotated about its axis to effect separation. The rotation can be rapid enough to create centrifugal forces which hold the granular material against the outer screen wall (of each concentric annular region). The entire unit can be vibrated (in a manner analogous to typical batch stacked-screen sieves which are vibrated) to achieve size separation. After size-separation into each concentric annulus (between cylindrical screens), the separated material can be removed.

For continuous processing a variety of embodiments can be made which use the basic centrifugal sieve concept. The tested prototype used a rapidly rotating cylindrical screen with granular material transported axially along the inside surface of the screen via a compliant screw auger. The compliant auger was rotated somewhat faster than the screen to effect screw-conveying of the material along the screen-wall. The fine-fraction passed through the outer screen wall into a surrounding housing which captured the fines. The coarse fraction was transported axially completely through the cylindrical screen and out the other end, to a coarse-fraction collection hopper. One alternative embodiment without an auger would have the rotating cylinder tilted slightly in a gravity field and vibrated to allow gravity to provide axial displacement and the centrifugal force to cause sieving action. Another embodiment would use a rapidly rotating conical screen (preferably with a half-angle between 5 and 25 degrees) with granular feedstock introduced into the interior of the rotating conical frustum screen at the small end. Centrifugal force would hold the granular material on the rotating interior screen wall.

Vibrations motivate the materials to flow along the walls, shearing and segregating as it flows. The fines pass through the screen and the coarse material move out through the large end of the conical frustum. Some use a tapered compliant auger inside the conical screen frustum. Other configurations are possible, the centrifugal forces hold granular material to be sieved against rotating circular screens, and the shearing flow and vibration assist the separation of the fines through the rotating screens.

Innovative features of the present invention include a rotating outer conical or right circular cylindrical screen wall, rotating fast enough for the centrifugal forces near the wall to hold granular material against the rotating screen. Conventional so-called “centrifugal” sieves have a stationary screen and rapidly rotating blades that shear the granular solid near the stationary screen and effect the sieving process assisted by the air-flow inside the unit. The centrifugal sieves of this invention may (or may not) have an inner blade or blades, moving relative to the rotating wall screen. Some continuous flow embodiments would have no inner auger or blades, but achieve axial motion through vibration. In all cases the shearing action is gentler than conventional so-called centrifugal sieves which have very high velocity differences between the stationary outer screen and the rapidly rotating blades. The new design does not depend on air-flow in the sieving unit, so it will function just as well in vacuum as in air.

When centrifugal force is the primary body-force, and is combined with both shearing flow and vibratory motion, the centrifugal-sieve separators of the present invention can provide efficient gravity-level-independent size classification of granular feedstock like lunar regolith. The centrifugal size-separators of the present invention use the natural size stratification of flowing granular solids. They will function equally well under reduced gravity conditions and in vacuum. The nominal design is a configuration with only one moving part and no blades, or other high-wear components. Shearing flow and vibrations combined with a size-separating screen at the outside (or “bottom”) of the flow will separate particles, with the fines passing through the outer wall screen, and the coarse material passing axially through the continuous feed system. Multiple size separation streams are possible. The centrifugal-sieve concept can be scaled to any desired mass flow rate.

Size classification is used throughout the mineral, chemical and pharmaceutical industries. Improved methods for separation, especially gentle methods suitable for friable materials, could have wide applications. Granular solids are an integral part of the multi-billion dollar fundamental chemicals and agriculture industries. In extraterrestrial exploration and other lunar or space utilization, reliable, robust separation methods that operate independent of gravity level would be useful for granular materials size separation for regolith processor feedstock conditioning. For example, the centrifugal-sieves of this invention could remove regolith particles >0.5 cm diameter before dumping the material into a storage bin during excavation operations for oxygen extraction. The centrifuging sieves of this invention could also be used for a degree of mineral beneficiation to separate particles by size and thus, increase the concentration of particular minerals which are more prevalent in certain size fractions of bulk regolith. These centrifugal-sieves can operate in low-gravity (⅙-g and ⅜-g) and micro-gravity as well as use multiple feedstock sources.

One advantage of the present invention in batch sieving is that a batch-mode centrifugal sieve may accomplish the same sieving operation in much less time than a conventional stacked set of vibrated screens (which use gravity as the primary driving force for size separation).

An advantage of the continuous mode system is that it can be made with absolutely no gravity-flow components for feeding material into, or for extracting the separated size streams from, the centrifugal sieve. Thus the system is capable of functioning in a true micro-gravity environment as can exist on the surface of Phobos or other small extraterrestrial body. Another advantage of the continuous mode system is that some embodiments of the innovation have no internal blades or vanes, and thus, can be designed to handle a very wide range of feedstock sizes, including occasional very large oversize pieces, without jamming or seizing-up.

Prototype units have demonstrated good separation of very coarse materials greater than 5-mm from typical fine lunar regolith simulant material (JSC-1A simulant). Another prototype configuration (with a finer screen) was able to separate the component of JSC-1A below 0.1 mm in size from the portion that was larger than 0.1 mm. A reduced-gravity parabolic-flight capable prototype has been fabricated and plans have been made to test it under vacuum conditions and under reduced gravity conditions such as in a parabolic flight aircraft.

The centrifugal sieves can provide much faster batch processing of lab-scale quantities for size distribution analysis. Also, the mineral or primary materials industry may find the continuous centrifugal sieves to be more efficient or more compact than current technology for terrestrial operations.

Almost any commercial utilization of space minerals would benefit from the use of size separation equipment like the centrifugal sieves of the present invention.

A variety of embodiments of the present invention are suited to particular applications, e.g.,
1) Rapidly rotating cylindrical screens that use centrifugal force as the primary body-force driving size separation in batch-mode vibrated sieving;
2) Rapidly rotated conical frustum screens that use centrifugal force as the primary body-force driving size separation in a continuous-mode vibrated sieving wherein mixed-size feedstock is introduced inside of the small end of the conical screen, the fine-fraction passes through the conical screen wall, and the coarse fraction exits out the large end of the conical frustum screen;
3) Multiple concentric cylindrical screens used to produce a set of size-fractions of the original mixed-size material in batch mode;
4) Continuous-mode vibrated cylindrical sieves with an axis of rotation tilted down a small angle from horizontal (usually less than 25-degrees, preferably between 10 and 15-degrees), and the mixed-size feedstock introduced on the inside of the upper end of the (innermost) rotating cylindrical screen. Fine material passes through the cylindrical screen walls and the coarser material is retained inside of the screen and passes out the lower end of the cylindrical screen. With multiple concentric screens this embodiment can provide continuous size separation into multiple size-fractions;
5) Continuous-mode non-vibrated cylindrical sieves that use a helical blade, drag-chain, or brush, rotating somewhat faster than the cylindrical screen (or somewhat slower with a helix of the opposite hand), to convey granular material axially along the rotating cylindrical screen wall. The conveyed material is separated into fines, passing through the outer screen wall, and coarse-material conveyed axially through the cylinder and out the opposite end;
6) Continuous-mode non-vibrated conical sieves that use a tapered helical blade, drag-chain, or brush, rotating somewhat faster than the conical frustum screen (or somewhat slower with a helix of the opposite hand), to convey granular material axially along the rotating conical screen wall. The conveyed material is separated into fines, passing through the outer screen wall, and coarse-material is conveyed axially through the conical frustum and out the opposite end;
7) Continuous-mode non-vibrated cylindrical sieves with helical screw-blades, or helical coil-brushes attached to the outside of the cylindrical screen to assist in collecting and conveying the fine-fraction which passes through the rotating screen. The exterior helical blade or brushes wound with the opposite-hand of the helical conveying screw/brush inside of the screen, so that the fines would be conveyed to one end and the coarse material conveyed to the opposite end of the cylindrical sieve screen; and
8) Those in which the inlet-feed stream is delivered by way of a screw-conveyor, and transferred in a sealed manner to the conveying screw/brush which takes material through the rotating screen, and the outlet streams of coarse and fine material are connected in a sealed manner to separate screw conveyors so that all volatile gases which can be released in the system are contained within the enclosing conveying pipes/tubes of the screw conveyors delivering material to and from the sieving unit. Such a configuration would have no gravity-flow components and could function in any orientation with respect to gravity, and would be suitable for use in true micro-gravity as occurs on the surfaces of asteroids, comets, and/or small moons of various solar system planets.

In general, embodiments of the present invention can use a batch mode or a continuous flow mode. In batch mode, a rapidly rotating cylindrical screen with mixed-size granular material placed inside is vibrated so that the fines pass through the outer screen wall where they are collected.

In continuous flow mode, a rapidly rotating conical screen has mixed-size granular material introduced inside of the small end, and is vibrated so that material flows along its inner wall. The fines pass through the screen wall where it is collected, and the coarse material travels axially out the large end of the cone.

The rapid rotation of the cylindrical or conical screen provides a body force which can be controlled by the rotation rates. Thus speed controls can facilitate the size separation of the fine material from the coarse material. This body force can be several times greater than the body force that normal gravity induces. Sieve embodiments of the present invention can be constructed that do not depend on gravity-flow elements to introduce the materials or collect the products. Those are suitable for use in micro-gravity environments as found during space missions on the surfaces of asteroids and other small bodies in the Solar System.

Batch-mode, conventional size segregation or screening using stacked vibrated screens is a time consuming process. Using centrifugal force when gravity does not provide sufficient body force to effect rapid size separation can significantly shorten the processing times needed to segregate feedstocks into different sized fractions. Under reduced gravity, or microgravity, centrifugal sieve systems will function as well, or better than, conventional ones do on earth.

Conventional vibratory and mechanical blade sieving screens designed for earth conditions were tested under lunar gravity conditions and found not to function well. Centrifugal sievings of the present invention would do far better.

Mixed feedstock flow-streams can produce steady streams of fine and coarse materials in continuous-mode centrifugal sieves. Such a continuous process mode was demonstrated as part of a NASA funded Small Business Innovation Research (SBIR) project. Units with a similar design would be suitable for In Situ Resource Utilization (ISRU) processing of regolith feedstock under Martian, Lunar, or other extraterrestrial body surface conditions. Such centrifugal sieves can be scaled to any practical sizes and mass flow rates. For example, for small robotic exploratory extraterrestrial missions, or for semi-permanent processing of regolith for extraction of volatiles of minerals.

Almost all terrestrial size-separation processes depend on gravity to flow the incoming feedstock and size-fraction exit streams. Two-phase, fluid-solid or gas-solid cyclone separators, or hydro cyclones are the exceptions. True, dry granular material micro-gravity capable versions of continuous-mode centrifugal-sieves are the focus of the present invention.

Generally speaking, in conical screen applications the screen rotation rates and radii should be enough in combination to produce about 1.5 gravitational units (G's) of centrifugal force at the inner surfaces of the screen. The minimum useful amount would be 1.2 G's and is easily set by the motor speeds. In cylindrical screen applications, the G-forces will be essentially uniform everywhere on the inner screen surfaces.

If the centrifugal forces developed drop below 1.5-G's, the beds of material on the screen surfaces can slide back circumferentially a little as they move around a circular path. We do not know if that would be beneficial in screening, so our prototypes were built without depending on that.

The centrifugal forces that push the material outward increase in proportion to the enlarging screen radius. They reach maximum at the largest end of the screen. Thus, as the material pushes farther along the conical sieve axis, the materials particles are pressed outwards more firmly. Although not tested, it seems sieving would improve. The increasing material bed area also can induce more shearing. The higher G-levels and auger conveyers both produce shearing and motivate the fines to sift through the screens.

Although the present invention has been described in terms of the presently preferred embodiments, it is to be understood that the disclosure is not to be interpreted as limiting. Various alterations and modifications no doubt become apparent to those skilled in the art after having read the above disclosure. Accordingly, it is intended that the appended claims be interpreted as covering all alterations and modifications as fall within the “true” spirit and scope of the present invention. cm What is claimed is:

1. A dry granular material sieve for nearly gravity-independent operation capable of sieving under gravity environments ranging from microgravity to terrestrial gravity, comprising:
means that rotates and vibrates a circular cylindrical or conical screen that sifts through finer particles from a dry granular mix material from its interior to its exterior;
means that continuously conveys in said dry granular mix material as an input feedstock to said interior of a first end of said circular cylindrical or conical screen;
means that continuously conveys away said finer particles of material from said exterior of said circular cylindrical or conical screen;
means that continuously conveys away any remaining said dry granular mix material at a second end of said circular cylindrical or conical screen;

2. The dry granular material sieve for operation in gravity environments ranging from microgravity to terrestrial gravity of claim 1, further comprising:
means that controls and varies the speeds of rotation and vibration of said circular cylindrical or conical screen.

3. The dry granular material sieve for operation in gravity environments ranging from microgravity to terrestrial gravity of claim 1, further comprising:
means that independently controls, varies, and balances the speeds of rotation of said circular cylindrical or conical screen, the means that continuously conveys said dry granular mix material, the means that continuously conveys away said finer particles of material, and the means that continuously conveys away any remaining said dry granular mix material.

4. The dry granular material sieve for operation in gravity environments ranging from microgravity to terrestrial gravity of claim 1, further comprising:
means that screw augers said dry granular mix material in a continuous flow through a conveyor.

5. The dry granular material sieve for operation in gravity environments ranging from microgravity to terrestrial gravity of claim 1, further comprising:
means that screw augers said finer particles of material in a continuous flow away through a conveyor.

6. The dry granular material sieve for operation in gravity environments ranging from microgravity to terrestrial gravity of claim 1, further comprising:
means that screw augers away said remaining dry granular mix material in a continuous flow through a conveyor.

7. The dry granular material sieve for operation in gravity environments ranging from microgravity to terrestrial gravity of claim 1, further comprising:
means that screw augers away said finer particles of material in a continuous flow through a fines conveyor; and
means that screw augers said finer particles of material with a cylindrical or conical helix mounted to the exterior of circular or conical cylindrical screen and that delivers them to said fines conveyor.

8. The dry granular material sieve for operation in gravity environments ranging from microgravity to terrestrial gravity of claim 1, further comprising:
means that screw augers away said remaining dry granular mix material in a continuous flow through a remains conveyor; and
means that screw augers said dry granular mix material input feedstock through said interior of said circular cylindrical or conical screen and delivers said remaining dry granular mix material to said remains conveyor.
